(19) United States
(12) Patent Application Publication
(10) Pub. No.: US 2009/0103308 A1
(43) Pub. Date: Apr. 23, 2009

(54) LED LAMP WITH A HEAT SINK

(75) Inventors: FANG-WEI XU, Shenzhen (CN); GUANG YU, Shenzhen (CN); CHENG-TIEN LAI, Tu-Cheng (TW)

Correspondence Address: PCE INDUSTRY, INC.;ATT. Steven Reiss, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/013,379

(22) Filed: Jan. 11, 2008

(30) Foreign Application Priority Data
Oct. 19, 2007 (CN) 200710123994.6

(51) Int. Cl. F21V 29/00

(52) U.S. Cl. 362/294

(57) ABSTRACT

An LED lamp includes a plurality of LED modules, a cone-shaped heat absorbing member, a heat sink and an envelope. The heat absorbing member comprises a plurality of heat absorbing portions. Each of the heat absorbing portions has a configuration like a triangular pyramid and comprises a sector base and an inclined surface extending from an edge of the sector base to a single apex. Each of the LED modules is attached on a corresponding inclined surface. The heat sink thermally connects with the heat absorbing member. The envelope is mounted below the heat sink and engages with the heat sink to enclose the heat absorbing member and the LED modules therein. Heat generated by the LED modules is first absorbed by the heat absorbing member and then dissipated to ambient air through the heat sink.

### BACKGROUND OF THE INVENTION

1. Field of the Invention

The present invention relates to a light emitting diode (LED) lamp, and more particularly to an LED lamp having a heat sink for improving heat dissipation efficiency of the LED lamp.

2. Description of Related Art

The technology of LED has been rapidly developed in recent years from indicators to illumination applications. With the features of long-term reliability, environment friendliness and low power consumption, the LED is viewed as a promising alternative for future lighting products. LEDs are widely used in many fields. Nevertheless, the rate of heat generation increases with the illumination intensity. This issue has become a challenge for engineers to design the LED illumination, i.e., the LED lamp.

What is needed, therefore, is an LED lamp which has greater heat-transfer and heat dissipation capabilities, whereby the LED lamp can operate normally for a sufficiently long period of time.

### SUMMARY OF THE INVENTION

An LED lamp includes a plurality of LED modules, a heat absorbing member, a heat sink and an envelope. The heat absorbing member comprises a plurality of heat absorbing portions. Each of the heat absorbing portions comprises a sector base and a flat, inclined surface extending from an edge of the sector base to a single apex. Each of the LED modules is attached on a corresponding inclined surface. The heat sink thermally connects with the heat absorbing member. The envelope is mounted below the heat sink and engages with the heat sink to enclose the heat absorbing member and the LED modules therein. The envelope is made of transparent material such as glass or plastic.

Other advantages and novel features of the present invention will become more apparent from the following detailed description when taken in conjunction with the accompanying drawings, in which:

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of an LED lamp with a heat sink in accordance with a preferred embodiment of the present invention;

FIG. 2 is an exploded view of FIG. 1;

FIG. 3 is a view similar to FIG. 2, but shown from another aspect; and

FIG. 4 is a top view of the heat sink of FIG. 2.

### DETAILED DESCRIPTION OF THE INVENTION

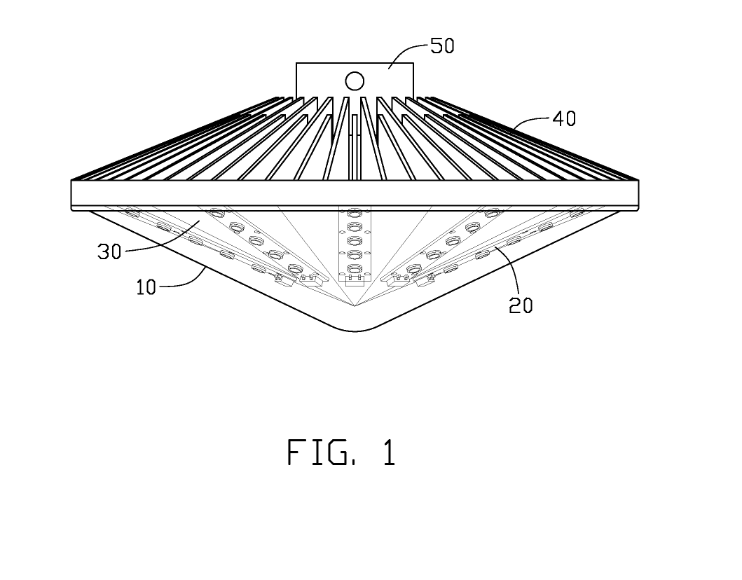

Referring to FIG. 1, an LED lamp adapted for a lighting purpose comprises a plurality of LED modules 20, a heat absorbing member 30 for supporting and cooling the LED modules 20, and a heat sink 40 connected with the heat absorbing member 30 and located at top of the heat absorbing member 30, and an envelope 10 mounted below the heat sink 40 and enclosing the heat absorbing member 30 and the LED modules 20 therein. A socket 50 is located at a centre of the heat sink 40.

The envelope 10 has a bowl-shaped construction, with a concave surface (not labeled) facing upwardly toward the heat absorbing member 30. The envelope 10 is generally made of transparent plastic, glass, or other suitable material availing to transmit light.

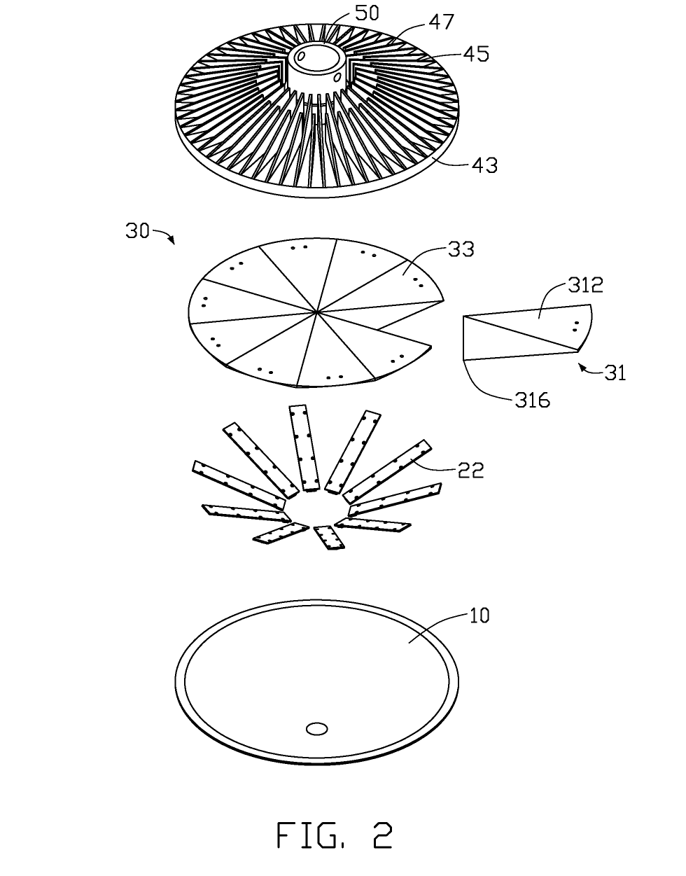

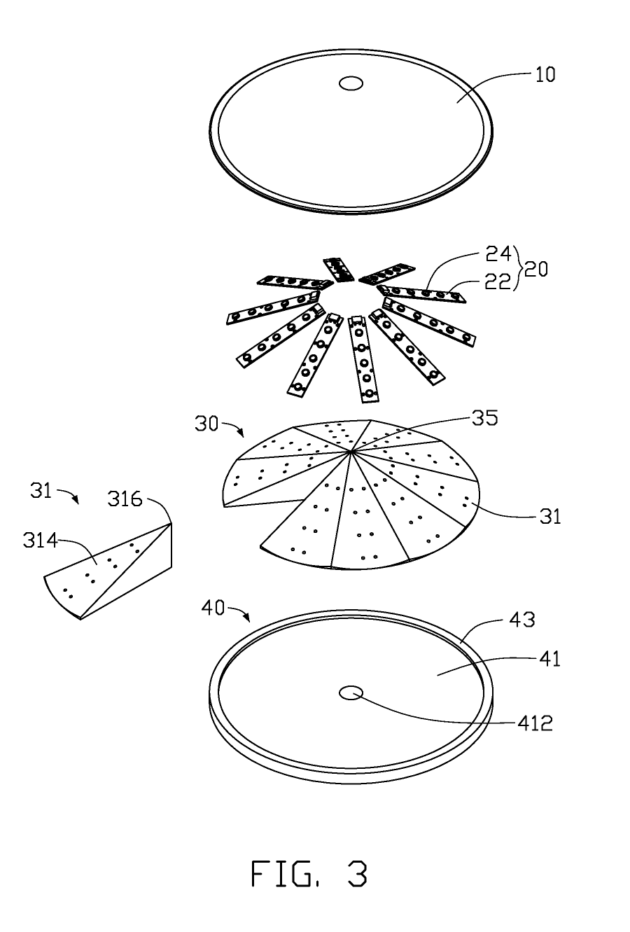

Referring to FIGS. 2-3 also, each LED module 20 comprises an elongated printed circuit board 22 and a plurality of spaced LEDs 24 evenly mounted on a side of the printed circuit board 22. The LEDs 24 of each LED module 20 are arranged along a longitudinal direction of the printed circuit board 22. Each LED module 20 has a thermally conductive relationship with the heat absorbing member 30.

The heat absorbing member 30 has an inverted, cone-shaped configuration and is made from metal such as aluminum. The heat absorbing member 30 consists of a plurality of heat absorbing portions 31. Each of the heat absorbing portions 31 has a configuration of a triangular pyramid with a vertical edge (not labeled). Each of the heat absorbing portions 31 comprises a sector base 312 with an arced edge, a triangular, flat and inclined surface 314 extending from the arced edge of the sector base 312 to a single apex 316, and other two triangular surfaces (not labeled) interconnecting the sector base 312 and the apex 316. The vertical edge (not labeled) is vertically extended downwardly from the apex 316. The heat absorbing portions 31 are identical to each other and centrosymmetrical relative to a central axis of the heat absorbing member 30 which is cooperatively defined by the vertical edges of the heat absorbing portions 31. The sector bases 312 of the heat absorbing portions 31 are assembled to form a circular base 33 for thermally contacting with the heat sink 40. The arced edges of the sector bases 312 form an outmost circular edge (not labeled) of the circular base 33. The apexes 316 of the heat absorbing portions 31 are assembled to form a central apex 35 of the heat absorbing member 30 and the inclined surfaces 314 of the heat absorbing portions 31 are radially disposed around the central apex 35 to support the LED modules 20. Each of the LED modules 20 is attached to the inclined surface 314 of each heat absorbing portion 31. The printed circuit board 22 of each of the LED modules 20 extends along a longitudinal direction from the arced edge to the apex 316 of each heat absorbing portion 31. A number of the heat absorbing portions 31 is identical to that of the LED modules 20 and can be different in different embodiments. In this embodiment, the number of the heat absorbing portions 31 and the LED modules 20 are both ten. A lightness of the LED lamp is changed via a change of the number of the LED modules 20.

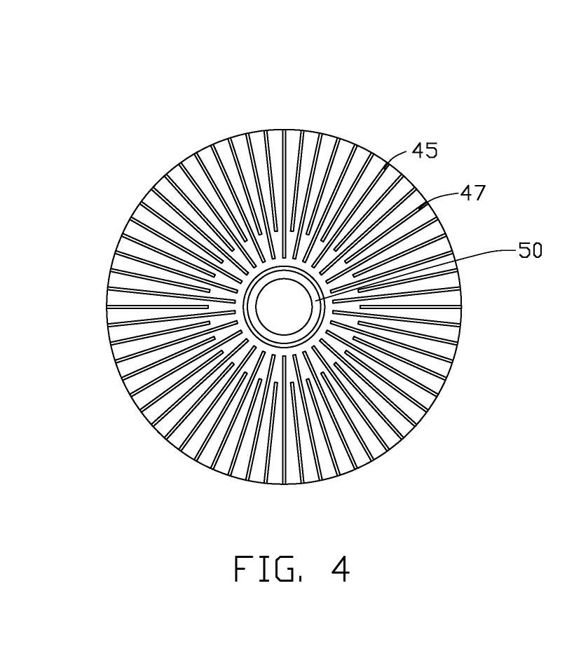

Referring to FIG. 4 also, the heat sink 40 has a discal configuration and is made from metal such as aluminum. The heat sink 40 comprises a base 41, an annular sidewall 43 extending downwardly from an outmost edge of the base 41 and a plurality of first and second fins 45, 47 radially mounted on a top surface of the base 41. A central hole 412 is defined in a centre of the base 41 for facilitating wires to extend therethrough. A recess (not labeled) is defined at a top centre of the base 41 of the heat sink 40. The first and the second fins 45, 47 extend from an outmost edge of the base 41 to a centre of the heat sink 40 and around the recess of the base 41. Each of the first fins 45 has a length longer than that of each of the second fins 47. Each of the first fins 45 and each of the second fins 47 are alternately and evenly spaced apart from each other.

The heat absorbing member 30 is attached to the bottom of the base 41 of the heat sink 40 via the circular base 33 of the heat absorbing member 30 adhered to a bottom surface of the base 41. The envelope 10 engages with the annular sidewall 43 of the heat sink 40. Therefore, the heat sink 40 and the envelope 10 together define an enclosed housing (not labeled) accommodating the heat absorbing member 30 with the LED modules 20 therein, whereby the LED modules 20 can have a sufficient protection for preventing a damage caused by an unexpected force from acting on the LED lamp.

The socket 50 is located at the recess of the base 41 of the heat sink 40 and has a hollow cylindrical configuration. A driving circuit module (not shown) is received in the socket 50. Wires (not shown) of the driving circuit module extend through the central hole 412 of the base 41 of the heat sink 40 to electrically connect with the LED modules 20.

In use, when the LEDs 24 of the LED modules 20 emit light, heat generated by the LEDs 24 is absorbed by the heat absorbing member 30 and then transfers to the first and the second fins 45, 47 of the heat sink 40 mounted on the top surface of the base 41. Finally, the heat is dispersed into ambient cool air via the first and second fins 45, 47. Thus, a temperature of the LEDs 24 is decreased and the LED lamp has an improved heat dissipating efficiency for preventing the LEDs 24 from overheating. On the other hand, the inclined surfaces 314 of the heat absorbing member 30 are radially disposed at the heat absorbing member 30 around the central apex 35 and the LED modules 20 are attached on the inclined surfaces 314 of the heat absorbing member 30; thus, light radiated from the LED modules 20 is distributed over a large region.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp comprising:
a plurality of LED modules;
a heat absorbing member comprising a plurality of heat absorbing portions, each of the heat absorbing portions comprising a sector base, an inclined surface extending from an edge of the sector base to a single apex, each of the LED modules being attached on the inclined surface;
a heat sink thermally contacting with the sector bases of the heat absorbing portions; and
an envelope mounted below the heat sink and engaging with the heat sink to enclose the heat absorbing member and the LED modules therein.

2. The LED lamp of claim 1, wherein each of the heat absorbing portions has a configuration of a triangular pyramid and the heat absorbing portions are centrosymmetrical relative to a central axis of the heat absorbing member.

3. The LED lamp of claim 1, wherein the sector bases of the heat absorbing portions are assembled to form a circular base to thermally contact with the heat sink.

4. The LED lamp of claim 3, wherein the apexes of the heat absorbing portions are assembled to form a central apex of the heat absorbing member and the inclined surfaces of the heat absorbing portions are radially disposed around the central apex to support the LED modules.

5. The LED lamp of claim 4, wherein each of the LED modules extends along a longitudinal direction from the edge of the sector base to the apex of each of the heat absorbing portions.

6. The LED lamp of claim 1, wherein the heat sink has a discal configuration and comprises a base, a sidewall extending downwardly from an outmost edge of the base and a plurality of first and second fins radially mounted on a top surface of the base.

7. The LED lamp of claim 6, wherein the first and the second fins extend from the outmost edge of the base to a centre of the heat sink, and each of the first fins has a length longer than that of each of the second fins.

8. The LED lamp of claim 7, wherein each of the first fins and each of the second fins are alternately spaced apart from each other.

9. The LED lamp of claim 1 further comprising a socket located at a centre of the heat sink.

10. The LED lamp of claim 1, wherein each of the LED modules comprises an elongated printed circuit board and a plurality of spaced LEDs mounted on a side of the printed circuit board.

11. An LED lamp comprising:
a plurality of LED modules;
a heat absorbing member for supporting and cooling the LED modules, the heat absorbing member comprising a base and a plurality of inclined surfaces extending from an edge of the base to a central apex of the heat absorbing member, the inclined surfaces radially disposed around the central apex, each of the LED modules being attached on a corresponding one of the inclined surfaces;
a heat sink located at a top of the heat absorbing member and thermally contacting with the base of the heat absorbing member; and
an envelope mounted below the heat sink and engaging with the heat sink to enclose the heat absorbing member and the LED modules therein.

12. The LED lamp of claim 11, wherein the heat absorbing member has an inverted, cone-shaped configuration.

13. The LED lamp of claim 1, wherein the heat sink comprises a base, a sidewall extending downwardly from an outmost edge of the base and a plurality of fins radially mounted on a top surface of the base, the base of the heat absorbing member is attached on the base of the heat sink.

14. An LED lamp comprising:
a cone-shaped heat absorbing member having a flat base, an apex and a side face between the apex and the flat base, the side face having a plurality of flat sections between the apex and the flat base;
a plurality of LED modules each being mounted on a corresponding flat section, wherein each LED module has a printed circuit board and a plurality of LEDs on the printed circuit board;
a heat sink having a base thermally connecting with the flat base of the heat absorbing member and a plurality of fins, whereby heat generated by the LEDs of the LED modules is first received by the heat-absorbing member and then dissipated to ambient air via the fins of the heat sink.

15. The LED lamp of claim 14 further comprising an envelope connecting with the heat sink and cooperating with the heat sink to define a space receiving the heat absorbing member and the LED modules therein.

16. The LED lamp of claim 15, wherein the envelope is made of one of glass and plastic.

17. The LED lamp of claim 16, wherein the heat sink has a discal configuration and a face opposite the base thereof, the fins being radially formed on the face of the heat sink, an annular sidewall extending from the a periphery of base and engaging with the envelope.

18. The LED lamp of claim 14, wherein each of the flat sections of the side face of the heat absorbing member has a triangular shape.
